(19) United States
(12) Patent Application Publication
(10) Pub. No.: US 2024/0290057 A1
(43) Pub. Date: Aug. 29, 2024

(54) PROCESSING APPARATUS AND METHOD PERFORMED BY PROCESSING APPARATUS

(71) Applicants: KEIO UNIVERSITY, Tokyo (JP); HONDA MOTOR CO., LTD., Tokyo (JP)

(72) Inventors: Yoshimitsu Aoki, Yokohama-shi (JP); Kentaro Yoshikawa, Yokohama-shi (JP); Takuma Mori, Wako-shi (JP); Yoichi Natori, Wako-shi (JP); Kenji Nishimiya, Wako-shi (JP)

(21) Appl. No.: 18/429,505

(22) Filed: Feb. 1, 2024

(30) Foreign Application Priority Data
Feb. 24, 2023 (JP) 2023-027703

(51) Int. Cl. G06V 10/20; G06T 7/277; G06T 7/73

(52) U.S. Cl. CPC G06V 10/20; G06T 7/277; G06T 7/73

(57) ABSTRACT

A processing apparatus includes: a processing portion that interpolates, when at least one of two-dimensional image information and three-dimensional sensor information that are input at an arbitrary time is missing, the missing two-dimensional image information or the missing three-dimensional sensor information and outputs an object detection result based on the interpolated two-dimensional image information and the interpolated three-dimensional sensor information to an object-tracking apparatus, wherein the processing portion interpolates the missing one of the two-dimensional image information and the three-dimensional sensor information with conversion of another of the two-dimensional image information and the three-dimensional sensor information, or interpolates the two-dimensional image information or the three-dimensional sensor information at a missing time with estimation based on two-dimensional image information or three-dimensional sensor information at another time.

### CROSS-REFERENCE TO RELATED APPLICATION

Priority is claimed on Japanese Patent Application No. 2023-027703, filed on Feb. 24, 2023, the contents of which are incorporated herein by reference.

### BACKGROUND

### Field of the Invention

The present invention relates to a processing apparatus and a method performed by the processing apparatus.

### Background

Object detection in three dimensions is expected to be applied to self-driving of vehicles and robots and is being extensively studied. A LiDAR (Light Detection and Ranging) that acquires a captured surrounding situation as point group data and a camera sensing technique that acquires the captured surrounding situation as image data perform important functions for detecting an object in a three-dimensional space. In recent years, methods using a multi-sensor that also utilize an RGB image obtained from a camera in addition to the point group data from the LiDAR have also emerged. This is because in the method using a multi-sensor, the LiDAR that sparsely measures an absolute distance to an object and a camera that densely captures the hue of an object using a large number of pixels mutually compensate for advantages and disadvantages, and further effects are achieved.

With respect to techniques for detecting an object, a technique is known in which the position of an object on a screen is identified (for example, refer to Japanese Unexamined Patent Application, First Publication No. 2021-67649). This technique acquires a reflection light image including distance information obtained by detecting reflection light in response to light irradiation by a light reception element, a background light image including brightness information obtained by detecting background light with respect to the reflection light by the light reception element, and a camera image captured by a different camera element from the light reception element, and estimates the amount of movement of an estimation target by using information of a captured target detected in the reflection light image, the background light image, and the camera image in common.

### SUMMARY

In a multi-sensor, a timing when each of a plurality of sensors captures the environment and a time when features are extracted from the detected information are different. Therefore, when the features extracted by each of the multi-sensor are integrated, a timing when information from each sensor is missing occurs.

Further, there is a possibility that information from each sensor may be missing at an arbitrary (indeterminate) timing due to the state of the plurality of sensors and a computer (calculation device), a communication situation between each sensor and the computer (calculation device), or the like.

An object of an aspect of the present invention is to provide a processing apparatus and a method performed by the processing apparatus capable of outputting, even when at least one of two-dimensional image information and three-dimensional sensor information that are input at an arbitrary time is missing, an object detection result based on two-dimensional image information and three-dimensional sensor information obtained by interpolating the missing two-dimensional image information or the missing three-dimensional sensor information to an object-tracking apparatus.

A processing apparatus according to a first aspect of the present invention includes: a processing portion that interpolates, when at least one of two-dimensional image information and three-dimensional sensor information that are input at an arbitrary time is missing, the missing two-dimensional image information or the missing three-dimensional sensor information and outputs an object detection result based on two-dimensional image information and three-dimensional sensor information obtained by interpolating the missing two-dimensional image information or the missing three-dimensional sensor information to an object-tracking apparatus, wherein the processing portion interpolates the missing one of the two-dimensional image information and the three-dimensional sensor information with conversion of another of the two-dimensional image information and the three-dimensional sensor information, or interpolates the two-dimensional image information or the three-dimensional sensor information at a missing time with estimation based on two-dimensional image information or three-dimensional sensor information at another time.

A second aspect is the processing apparatus according to the first aspect described above which may further include: a three-dimensional object detection portion that detects, when three-dimensional sensor information is missing, a three-dimensional object included in three-dimensional sensor information close to the missing three-dimensional sensor information; and a position estimation portion that estimates a position of a three-dimensional object interpolated based on a position of the three-dimensional object detected by the three-dimensional object detection portion, wherein the processing portion may interpolate the missing three-dimensional sensor information based on position information of the interpolated three-dimensional object estimated by the position estimation portion.

A third aspect is the processing apparatus according to the second aspect described above, wherein the three-dimensional object detection portion may detect a three-dimensional object included in each of a plurality of three-dimensional sensor information prior to the missing three-dimensional sensor information, and the position estimation portion may estimate the position of the interpolated three-dimensional object based on an average value of a plurality of positions of the three-dimensional object detected by the three-dimensional object detection portion.

A fourth aspect is the processing apparatus according to the second aspect described above, wherein the three-dimensional object detection portion may detect a three-dimensional object included in each of a plurality of three-dimensional sensor information prior to the missing three-dimensional sensor information, and the position estimation portion may derive a movement speed and an acceleration from a plurality of positions of the three-dimensional object detected by the three-dimensional object detection portion and may estimate the position of the interpolated three-dimensional object based on the derived movement speed and the derived acceleration.

A fifth aspect is the processing apparatus according to the second aspect described above, wherein the position estimation portion may estimate a position of the three-dimensional object after the missing three-dimensional sensor information from a position of the three-dimensional object detected by the three-dimensional object detection portion and may estimate the position of the interpolated three-dimensional object based on the estimated position of the three-dimensional object.

A sixth aspect is the processing apparatus according to the first aspect described above which may further include: a three-dimensional object detection portion that detects, when three-dimensional sensor information is missing, a three-dimensional object from two-dimensional image information close to the missing three-dimensional sensor information, wherein the processing portion may interpolate the missing three-dimensional sensor information with the three-dimensional object detected by the three-dimensional object detection portion.

A seventh aspect is the processing apparatus according to the first aspect described above which may further include: a two-dimensional object detection portion that detects, when two-dimensional image information is missing, a two-dimensional object included in two-dimensional image information close to the missing two-dimensional image information; and a position estimation portion that estimates a position of a two-dimensional object interpolated based on a position of the two-dimensional object detected by the two-dimensional object detection portion, wherein the processing portion may interpolate the missing two-dimensional image information based on position information of the interpolated two-dimensional object estimated by the position estimation portion.

An eighth aspect is the processing apparatus according to the seventh aspect described above, wherein the two-dimensional object detection portion may detect a two-dimensional object included in each of a plurality of two-dimensional image information prior to the missing two-dimensional image information, and the position estimation portion may estimate the position of the interpolated two-dimensional object based on an average value of a plurality of positions of the two-dimensional object detected by the two-dimensional object detection portion.

A ninth aspect is the processing apparatus according to the seventh aspect described above, wherein the two-dimensional object detection portion may detect a two-dimensional object included in each of a plurality of two-dimensional image information prior to the missing two-dimensional image information, and the position estimation portion may derive a movement speed and an acceleration from a plurality of positions of the two-dimensional object detected by the two-dimensional object detection portion and may estimate the position of the interpolated two-dimensional object based on the derived movement speed and the derived acceleration.

A tenth aspect is the processing apparatus according to the seventh aspect described above, wherein the position estimation portion may estimate a position of the two-dimensional object after the missing two-dimensional image information from a position of the two-dimensional object detected by the two-dimensional object detection portion and may estimate the position of the interpolated two-dimensional object based on the estimated position of the two-dimensional object.

An eleventh aspect is the processing apparatus according to the first aspect described above which may further include: a two-dimensional object detection portion that detects, when two-dimensional image information is missing, a two-dimensional object from three-dimensional sensor information close to the missing two-dimensional image information, wherein the processing portion may interpolate the missing two-dimensional image information with the two-dimensional object detected by the two-dimensional object detection portion.

A twelfth aspect of the present invention is a method performed by a processing apparatus, the method including: interpolating, when at least one of two-dimensional image information and three-dimensional sensor information that are input at an arbitrary time is missing, the missing two-dimensional image information or the missing three-dimensional sensor information; outputting an object detection result based on two-dimensional image information and three-dimensional sensor information obtained by interpolating the missing two-dimensional image information or the missing three-dimensional sensor information to an object-tracking apparatus; and when the missing two-dimensional image information or the missing three-dimensional sensor information is interpolated, interpolating the missing one of the two-dimensional image information and the three-dimensional sensor information with conversion of another of the two-dimensional image information and the three-dimensional sensor information, or interpolating the two-dimensional image information or the three-dimensional sensor information at a missing time with estimation based on two-dimensional image information or three-dimensional sensor information at another time. According to the first to twelfth aspects described above, even when at least one of two-dimensional image information and three-dimensional sensor information that are input at an arbitrary time is missing, it is possible to output an object detection result based on two-dimensional image information and three-dimensional sensor information obtained by interpolating the missing two-dimensional image information or the missing three-dimensional sensor information to an object-tracking apparatus.

### BRIEF DESCRIPTION OF THE DRAWINGS

FIG. 1 is a view showing an example of an object-tracking system according to the present embodiment.

FIG. 2 is a view showing an example 1 of a processing apparatus of the object-tracking system according to the present embodiment.

FIG. 3A is a view showing an example 1 of an operation of the processing apparatus of the object-tracking system according to the present embodiment.

FIG. 3B is a view showing an example 2 of an operation of the processing apparatus of the object-tracking system according to the present embodiment.

FIG. 3C is a view showing an example 3 of an operation of the processing apparatus of the object-tracking system according to the present embodiment.

FIG. 4 is a view showing an example 2 of a processing apparatus of the object-tracking tracking system according to the present embodiment.

FIG. 5 is a view showing an example 4 of an operation of the processing apparatus of the object-tracking system according to the present embodiment.

FIG. 6 is a view showing an example 3 of a processing apparatus of the object-tracking system according to the present embodiment.

FIG. 7A is a view showing an example 5 of an operation of the processing apparatus of the object-tracking system according to the present embodiment.

FIG. 7B is a view showing an example 6 of an operation of the processing apparatus of the object-tracking system according to the present embodiment.

FIG. 7C is a view showing an example 7 of an operation of the processing apparatus of the object-tracking system according to the present embodiment.

FIG. 8 is a view showing an example 8 of a processing apparatus of the object-tracking system according to the present embodiment.

FIG. 9 is a view showing an example 8 of an operation of the processing apparatus of the object-tracking system according to the present embodiment.

FIG. 10 is a view showing an example of an operation of the object-tracking system according to the present embodiment.

FIG. 11 is a view showing an example 1 of an effect of the object-tracking system according to the present embodiment.

FIG. 12 is a view showing an example 2 of an effect of the object-tracking system according to the present embodiment.

### DESCRIPTION OF EMBODIMENTS

Next, a processing apparatus and a method performed by the processing apparatus of the present embodiment will be described with reference to the drawings. The embodiment described below is merely an example, and embodiments to which the present invention is applied are not limited to the following embodiment. In all of the drawings for describing the embodiment, the same reference numerals are used for components having the same function, and repetitive descriptions are omitted.

Further, the term “based on XX” in the present application means “based on at least XX” and also includes the case based on another element in addition to XX. Further, the term “based on XX” is not limited to the case in which XX is directly used but also includes the case based on an element obtained by performing calculation or processing on XX. “XX” is an arbitrary element (for example, arbitrary information).

### Embodiment

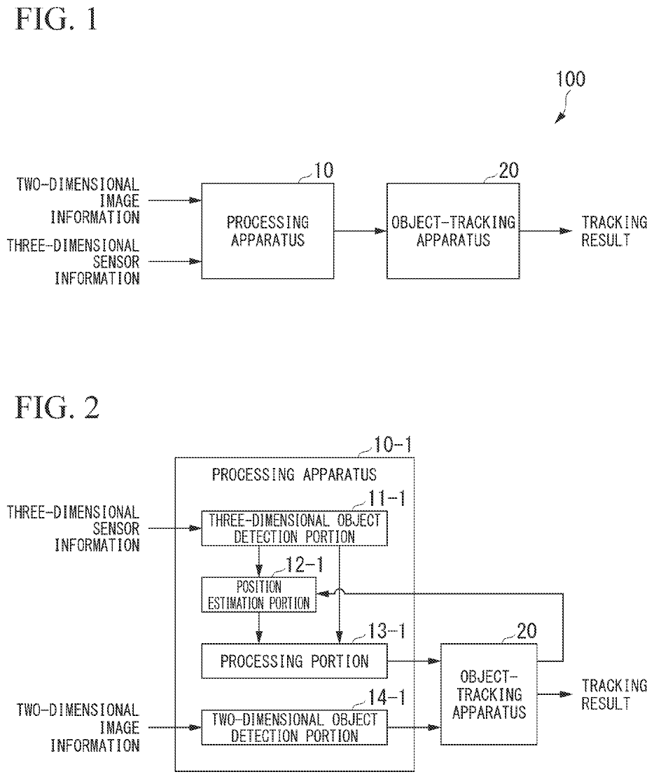

Hereinafter, an embodiment of the present invention will be described in detail with reference to the drawings. FIG. 1 is a view showing an example of an object-tracking system according to the present embodiment.

An object-tracking system 100 according to the present embodiment performs two-dimensional object tracking (2D Multi-Object Tracking) and three-dimensional object tracking (3D Multi-Object Tracking). The object-tracking system 100 includes a processing apparatus 10 and an object-tracking apparatus 20.

A frame (hereinafter, referred to as a “two-dimensional image frame”) of two-dimensional image information is input to the processing apparatus 10 in a first cycle. A frame (hereinafter, referred to as a “three-dimensional sensor frame”) of three-dimensional sensor information is input to the processing apparatus 10 in a second cycle. The first cycle and the second cycle may be the same as each other or may be different from each other. Hereinafter, as an example, the case where the first cycle and the second cycle are different from each other is described. An example of the two-dimensional image information is image data captured by a camera. The two-dimensional image is, for example, an RGB image and has a fine texture and color information. An example of the three-dimensional sensor information is point group data extracted from three-dimensional distances to a target object measured by the LiDAR. The three-dimensional sensor information includes point groups in a wide range. The two-dimensional image is superior in object recognition compared to the point group.

The processing apparatus 10 performs object detection with respect to the two-dimensional image frame that is input in the first cycle and the three-dimensional sensor frame that is input in the second cycle. The processing apparatus 10 outputs a result of performing object detection to the object-tracking apparatus 20. Specifically, the processing apparatus 10 generates a bounding box on the two-dimensional image frame.

Here, the bounding box is a rectangular frame that surrounds a region (object region) of an object captured in a two-dimensional image. The position and the size in two dimensions of the object can be recognized by the bounding box. The generation of the bounding box may be performed by a known technique that generates a bounding box such as object recognition technique that recognizes an object on a two-dimensional image.

Further, the processing apparatus 10 generates a bounding box on the three-dimensional sensor frame. Here, the bounding box is a rectangular frame that surrounds an object region obtained from point group data extracted from three-dimensional distances to an object measured by a three-dimensional sensor. The position, the size, and the orientation (orientation (direction) relative to a given reference) in three dimensions of the object can be recognized by the bounding box. The generation of the bounding box may be performed by a known technique that generates a bounding box such as object recognition technique that recognizes an object on point group data extracted from three dimensional distances to the object measured by the three-dimensional sensor.

Next, the processing apparatus 10 adds information indicating the type of an object to the object in the bounding box generated on the two-dimensional image frame. Further, the processing apparatus 10 adds information indicating the type of an object to the object in the bounding box generated on the three-dimensional sensor frame. The addition of the information indicating the type of the object may be performed by the processing apparatus 10 performing an algorithm which adds information indicating the classification of a known object.

Next, the processing apparatus 10 acquires an object detection result of an object to which predetermined information indicating the classification of the object is added among objects surrounded by the bounding box generated on the two-dimensional image frame. The processing apparatus 10 outputs the acquired object detection result (hereinafter, referred to as a “two-dimensional image object detection result”) to the object-tracking apparatus 20. The two-dimensional image object detection result is information identifying the bounding box to which information indicating the classification of the object is added. Further, the processing apparatus 10 acquires an object detection result (hereinafter, referred to as a “three-dimensional sensor object detection result”) of an object to which predetermined information indicating the classification of the object is added among objects surrounded by the bounding box generated on the three-dimensional sensor frame. The three-dimensional image object detection result is information identifying the bounding box to which information indicating the classification of the object is added. The processing apparatus 10 outputs the acquired two-dimensional image object detection result and the acquired three-dimensional sensor object detection result to the object-tracking apparatus 20.

When at least one of the two-dimensional image frame that is input in the first cycle and the three-dimensional sensor frame that is input in the second cycle is missing, the processing apparatus 10 interpolates two-dimensional image information of the missing two-dimensional image frame or point group data of the missing three-dimensional sensor frame. Specifically, the processing apparatus 10 interpolates the missing two-dimensional image frame with transformation of the point group data of the three-dimensional sensor frame or interpolates the missing three-dimensional sensor frame with transformation of the two-dimensional image information of the two-dimensional image frame. Alternatively, the processing apparatus 10 interpolates the two-dimensional image frame or the three-dimensional sensor frame at a missing time with estimation based on two-dimensional image information of the two-dimensional image frame or point group data of the three-dimensional sensor frame at another time.

The processing apparatus 10 performs object detection with respect to the two-dimensional image frame (hereinafter, referred to as an “interpolation two-dimensional image frame”) in which the missing two-dimensional image frame is interpolated or a three-dimensional sensor frame (hereinafter, referred to as an “interpolation three-dimensional sensor frame”) in which the missing three-dimensional sensor frame is interpolated. The processing apparatus 10 outputs a result of performing object detection to the object-tracking apparatus 20. Specifically, the processing apparatus 10 generates a bounding box on the interpolation two-dimensional image frame. Further, the processing apparatus 10 generates a bounding box on the interpolation three-dimensional sensor frame.

Next, the processing apparatus 10 adds information indicating the type of an object to the object in the bounding box generated on the interpolation two-dimensional image frame. Further, the processing apparatus 10 adds information indicating the type of an object to the object in the bounding box generated on the interpolation three-dimensional sensor frame.

Next, the processing apparatus 10 acquires a two-dimensional image object detection result to which predetermined information indicating the classification of the object is added among objects surrounded by the bounding box generated on the interpolation two-dimensional image frame. The processing apparatus 10 outputs the acquired two-dimensional image object detection result to the object-tracking apparatus 20. Further, the processing apparatus 10 acquires a three-dimensional sensor object detection result to which predetermined information indicating the classification of the object is added among objects surrounded by the bounding box generated on the interpolation three-dimensional sensor frame. The processing apparatus 10 outputs the acquired two-dimensional image object detection result and the acquired three-dimensional sensor object detection result to the object-tracking apparatus 20.

The object-tracking apparatus 20 acquires the two-dimensional image object detection result and the three-dimensional sensor object detection result that are output by the processing apparatus 10. The object-tracking apparatus 20 performs a two-dimensional object tracking that is an object tracking on a two-dimensional image or a three-dimensional object tracking that is an object tracking on a three-dimensional point group by using the acquired two-dimensional image object detection result and the acquired three-dimensional sensor object detection result.

Hereinafter, the processing apparatus 10 is described in detail. The processing apparatus 10 includes processing apparatuses 10-1 to 10-4. When a three-dimensional sensor frame is missing, the processing apparatus 10-1 performs interpolation by using point group data of a three-dimensional sensor frame other than the missing three-dimensional sensor frame. When a three-dimensional sensor frame is missing, the processing apparatus 10-2 performs interpolation by using two-dimensional image information of a two-dimensional image frame. When a two-dimensional image frame is missing, the processing apparatus 10-3 performs interpolation by using two-dimensional image information of a two-dimensional image frame other than the missing two-dimensional image frame. When a two-dimensional image frame is missing, the processing apparatus 10-4 performs interpolation by using point group data of a three-dimensional sensor frame. The processing apparatuses 10-1 to 10-4 are described below.

FIG. 2 is a view showing an example 1 of a processing apparatus of the object-tracking system according to the present embodiment. When a three-dimensional sensor frame is missing, the processing apparatus 10-1 performs interpolation by using point group data of a three-dimensional sensor frame other than the missing three-dimensional sensor frame. The processing apparatus 10-1 includes a three-dimensional object detection portion 11-1, a position estimation portion 12-1, a processing portion 13-1, and a two-dimensional object detection portion 14-1.

A three-dimensional sensor frame is input to the three-dimensional object detection portion 11-1. The three-dimensional object detection portion 11-1 generates a bounding box on the input three-dimensional sensor frame.

The three-dimensional object detection portion 11-1 adds information indicating the type of an object to the object in the bounding box generated on the three-dimensional sensor frame. The three-dimensional object detection portion 11-1 acquires a three-dimensional sensor object detection result of an object to which predetermined information indicating the classification of the object is added among objects surrounded by the bounding box generated on the three-dimensional sensor frame.

The three-dimensional object detection portion 11-1 outputs the acquired three-dimensional sensor object detection result to the object-tracking apparatus 20. For example, the three-dimensional object detection portion 11-1 is constituted of a 3D Object Detector (three-dimensional object detection device) and generates a bounding box on a three-dimensional sensor frame by utilizing an R-CNN.

When a three-dimensional sensor frame is missing, the three-dimensional object detection portion 11-1 acquires one or more three-dimensional sensor frames close to the missing three-dimensional sensor frame and generates a bounding box on each of the acquired one or more three-dimensional sensor frames. The three-dimensional object detection portion 11-1 adds information indicating the type of an object to the object in the bounding box generated on each of the one or more three-dimensional sensor frames.

The position estimation portion 12-1 estimates a position of an object interpolated based on the position of the bounding box generated on the one or more three-dimensional sensor frames by the three-dimensional object detection portion 11-1.

For example, the position estimation portion 12-1 estimates the position of the interpolated object by using an IoU (Intersection over Union). Here, the IoU is one of evaluation indexes available for object detection. The IoU is an index representing the percentage of the overlap of images and indicates that the images are further overlapped as the IoU is larger. Details of the process of estimating the position of an interpolated object will be described later.

The processing portion 13-1 acquires a result of adding the information indicating the type of the object to the object in the bounding box generated on each of the one or more three-dimensional sensor frames from the three-dimensional object detection portion 11-1, and acquires an estimation result of the position of the interpolated object from the position estimation portion 12-1. The processing portion 13-1 interpolates the three-dimensional sensor frame based on the acquired estimation result of the position of the interpolated object. For example, the processing portion 13-1 includes a three-dimensional Kalman filter, and the three-dimensional Kalman filter has position information of an object as an internal state. The three-dimensional Kalman filter outputs a feature of the object by updating the internal state based on the estimation result of the position of the interpolated object. The processing portion 13-1 interpolates the three-dimensional sensor frame by the feature of the object output by the three-dimensional Kalman filter. The processing portion 13-1 generates a bounding box for a result of interpolating the three-dimensional sensor frame by the feature of the object. The processing portion 13-1 acquires a three-dimensional sensor object detection result of an object to which predetermined information indicating the classification of the object is added among objects surrounded by the generated bounding box. The processing portion 13-1 outputs the acquired three-dimensional sensor object detection result to the object-tracking apparatus 20.

A two-dimensional image frame is input to the two-dimensional object detection portion 14-1. The two-dimensional object detection portion 14-1 generates a bounding box on the input two-dimensional image frame. The two-dimensional object detection portion 14-1 adds information indicating the type of an object to the object in the bounding box generated on the two-dimensional image frame. The two-dimensional object detection portion 14-1 acquires a two-dimensional object detection result of an object to which predetermined information indicating the classification of the object is added among objects surrounded by the bounding box generated on the two-dimensional image frame. The two-dimensional object detection portion 14-1 outputs the acquired two-dimensional object detection result to the object-tracking apparatus 20. For example, the two-dimensional object detection portion 14-1 is constituted of a 2D Object

Detector (two-dimensional object detection device) and generates a two-dimensional object detection result from a two-dimensional image frame by utilizing a Track RCNN. The object-tracking apparatus 20 acquires the three-dimensional sensor object detection result that is output by the processing portion 13-1 and acquires the two-dimensional object detection result that is output by the two-dimensional object detection portion 14-1. The object-tracking apparatus 20 tracks an object based on the acquired three-dimensional sensor object detection result and the acquired two-dimensional object detection result. For example, the object-tracking apparatus 20 tracks the object by using a Deep Fusion MOT (Multi-Object Tracking). The Deep Fusion MOT is a method for integrating feature amounts extracted independently by each sensor. The object-tracking apparatus 20 may output the result of the two-dimensional object tracking or the result of the three-dimensional object tracking to the position estimation portion 12-1. According to such a configuration, since the position estimation portion 12-1 can acquire track information (tracking information) to the previous frame based on the result of the two-dimensional object tracking or the result of the three-dimensional object tracking that are output by the object-tracking apparatus 20, the acquired track information to the previous frame can be used for the update (estimation of a position) of position information.

### Process of Estimating Position

Details of a process of estimating a position of an object interpolated by the position estimation portion 12-1 are described. The position estimation portion 12-1 estimates the position of an object interpolated based on one or more three-dimensional sensor frames close to the missing three-dimensional sensor frame. As an example, the case where the position estimation portion 12-1 estimates the position of an object interpolated based on two three-dimensional sensor frames acquired prior to a missing three-dimensional sensor frame is described separately for the case in which the interpolation is performed using an average value, the case in which the interpolation is performed by assuming a linear motion, and the case in which a Kalman filter is used.

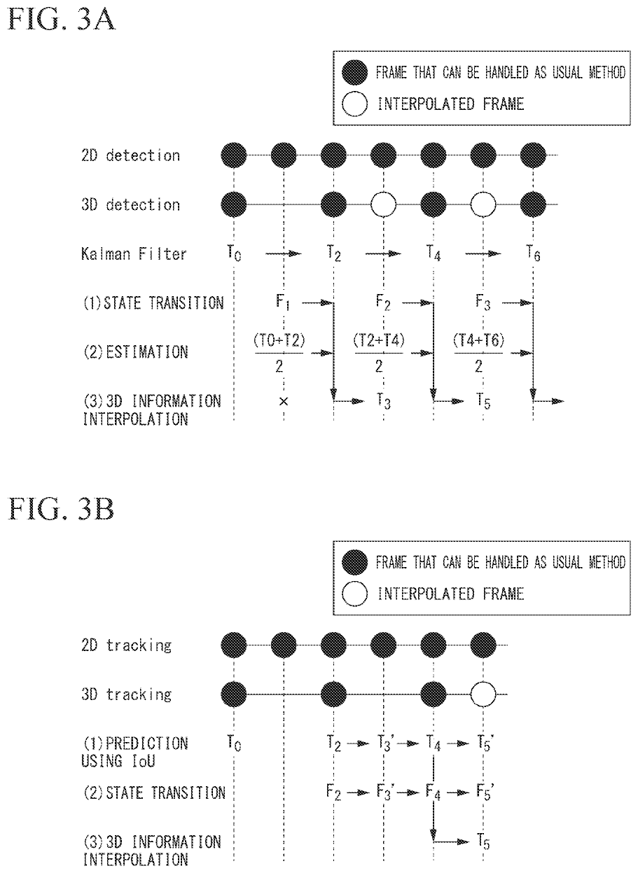

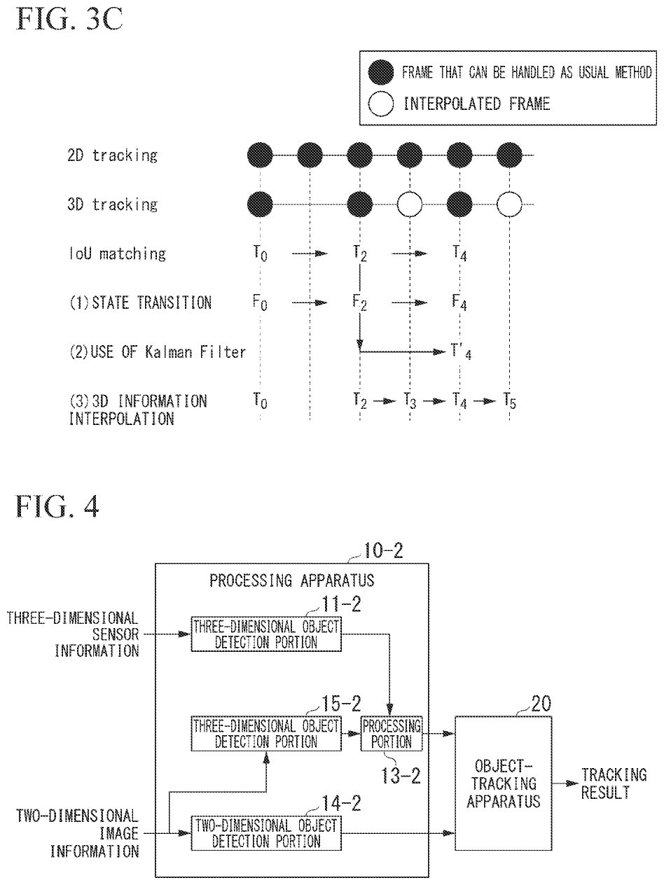

FIG. 3A is a view showing an example 1 of an operation of the processing apparatus of the object-tracking system according to the present embodiment. With reference to FIG. 3A, the case in which the interpolation is performed using an average value is described. In FIG. 3A, a lateral direction indicates time, a black circle indicates a frame that can be handled as usual, and a white circle indicates an interpolated frame.

The black circles aligned next to the 2D detection indicate two-dimensional image frames for which detection of an object is performed by the two-dimensional object detection portion 14-1, and the black circles aligned next to the 3D detection indicate three-dimensional sensor frames for which detection of an object is performed by a three-dimensional object detection portion 11. The white circles aligned next to the 3D detection indicate missing three-dimensional sensor frames.

In the processing portion 13-1, the 3D Kalman filter is updated to a state transition vector F1 by the result of detection of an object by the three-dimensional object detection portion 11-1 at a time T0 (1). The position estimation portion 12-1 acquires the result of detection of the object by the three-dimensional object detection portion 11-1 at a time T2. When a three-dimensional sensor frame at a time T3 is missing, the position estimation portion 12-1 derives a position at the time T0 and a position at the time T2 by using tracking information at the time T0 and tracking information at the time T2.

The position estimation portion 12-1 estimates a position at the time T3 from the position at the time T2 and the position at the time T0. For example, the position estimation portion 12-1 obtains a difference between the position at the time T0 and the position at the time T2 and estimates the position at the time T3 by adding the obtained difference divided by two to the position at the time T2 (2).

The estimation result of the position at the time T3 is input to the three-dimensional Kalman filter in the processing portion 13-1, and the feature of the object is acquired. The processing portion 13-1 performs interpolation using the feature of the object output by the three-dimensional Kalman filter (3).

Even when a three-dimensional sensor frame at a time T5 is missing, a similar process is performed by using the tracking information at the time T2 and the tracking information at the time T4, the estimation result of the position at the time T5 is input to the three-dimensional Kalman filter in the processing portion 13-1, and the feature of the object is acquired. The processing portion 13-1 performs interpolation using the feature of the object output by the three-dimensional Kalman filter (3).

FIG. 3B is a view showing an example 2 of an operation of the processing apparatus of the object-tracking system according to the present embodiment. With reference to FIG. 3B, the case in which the interpolation is performed by assuming a linear motion is described. In FIG. 3B, a lateral direction indicates time, a black circle indicates a frame that can be handled as usual, and a white circle indicates an interpolated frame. The black circles aligned next to the 2D tracking indicate two-dimensional image frames for which detection of an object is performed by the two-dimensional object detection portion 14-1, and the black circles aligned next to the 3D tracking indicate three-dimensional sensor frames for which detection of an object is performed by the three-dimensional object detection portion 11. The white circle aligned next to the 3D detection indicates a missing three-dimensional sensor frame.

The position estimation portion 12-1 acquires a result of detection of an object by the three-dimensional object detection portion 11-1 at a time T2. The position estimation portion 12-1 acquires a result of detection of an object by the three-dimensional object detection portion 11-1 at a time T4. When a three-dimensional sensor frame at a time T5 is missing, the position estimation portion 12-1 derives a position at the time T2 and a position at the time T4 by using tracking information at the time T2 and tracking information at the time T4 (1). The position estimation portion 12-1 assumes a linear motion by using the position at the time T2 and the position at the time T4, derives a speed from a time T0 to the time T2 based on the position at the time T0 and the position at the time T2, and derives a speed from the time T2 to the time T4 based on the position at the time T2 and the position at the time T4.

The position estimation portion 12-1 derives the acceleration from the difference between the speed from the time T0 to the time T2 and the speed from the time T2 to the time T4. The position estimation portion 12-1 estimates the position at the time T5 by using the derived acceleration. The estimation result of the position at the time T5 is input to the three-dimensional Kalman filter in the processing portion 13-1, and the feature of the object is acquired (2). The processing portion 13-1 performs interpolation using the feature of the object output by the three-dimensional Kalman filter (3).

FIG. 3C is a view showing an example 3 of an operation of the processing apparatus of the object-tracking system according to the present embodiment. With reference to FIG. 3C, the case in which a Kalman filter is used is described. In FIG. 3C, a lateral direction indicates time, a black circle indicates a frame that can be handled as usual, and a white circle indicates an interpolated frame. The black circles aligned next to the 2D tracking indicate two-dimensional image frames for which detection of an object is performed by a two-dimensional object detection portion 14, and the black circles aligned next to the 3D tracking indicate three-dimensional sensor frames for which detection of an object is performed by the three-dimensional object detection portion 11-1. The white circles aligned next to the 3D detection indicate missing three-dimensional sensor frames.

The position estimation portion 12-1 acquires the result of detection of the object by the three-dimensional object detection portion 11-1 at a time T2. When a three-dimensional sensor frame at a time T3 is missing, the position estimation portion 12-1 derives a position at the time T2 by using tracking information at the time T2.

The position estimation portion 12-1 inputs the position information at the time T2 into the three-dimensional Kalman filter of the processing portion 13 and acquires position information at a time T4 output by the three-dimensional Kalman filter ((1), (2)).

The position estimation portion 12-1 derives a change amount of the position between the time T2 and the time T4 by dividing the difference between the position at the time T4 and the position at the time T2 by two on the basis of the acquired position information at the time T4 and the position information at the time T2. The position estimation portion 12-1 estimates a position at the time T3 from the derived change amount of the position. The estimation result of the position at the time T3 is input to the three-dimensional Kalman filter in the processing portion 13-1, and the feature of the object is acquired. The processing portion 13-1 performs interpolation using the feature of the object output by the three-dimensional Kalman filter (3).

Even when a three-dimensional sensor frame at a time T5 is missing, a similar process is performed by using the tracking information at the time T2, and thereby, the position at the time T5 is estimated.

The estimation result of the position at the time T5 is input to the three-dimensional Kalman filter in the processing portion 13-1, and the feature of the object is acquired. The processing portion 13-1 performs interpolation using the feature of the object output by the three-dimensional Kalman filter.

FIG. 4 is a view showing an example 2 of a processing apparatus of the object-tracking system according to the present embodiment. When a three-dimensional sensor frame is missing, the processing apparatus 10-2 performs interpolation by using two-dimensional image information of a two-dimensional image frame. The processing apparatus 10-2 includes a three-dimensional object detection portion 11-2, a processing portion 13-2, a two-dimensional object detection portion 14-2, and a three-dimensional object detection portion 15-2.

The three-dimensional object detection portion 11-1 can be applied to the three-dimensional object detection portion 11-2. However, when the three-dimensional sensor frame is missing, the three-dimensional object detection portion 11-2 commands the processing portion 13-2 to output a three-dimensional sensor object detection result to the object-tracking apparatus 20.

The two-dimensional object detection portion 14-1 can be applied to the two-dimensional object detection portion 14-2.

A two-dimensional image frame is input to the three-dimensional object detection portion 15-2. The three-dimensional object detection portion 15-2 generates a bounding box on the input two-dimensional image frame. The three-dimensional object detection portion 15-2 adds information indicating the type of an object to the object in the bounding box generated on the two-dimensional image frame. The processing portion 13-2 acquires a three-dimensional sensor object detection result of an object to which predetermined information indicating the classification of the object is added among objects surrounded by the bounding box generated on the two-dimensional image frame.

When the command to output the three-dimensional sensor object detection result to the object-tracking apparatus 20 is input from the three-dimensional object detection portion 11-2, the processing portion 13-2 outputs the acquired three-dimensional sensor object detection result to the object-tracking apparatus 20. For example, the three-dimensional object detection portion 15-2 generates the bounding box by using a Monocular 3D Object Detection (single-eye three-dimensional object detection). When the command to output the three-dimensional sensor object detection result to the object-tracking apparatus 20 is input from the three-dimensional object detection portion 11-2, the processing portion 13-2 interpolates the missing three-dimensional sensor frame with a two-dimensional image frame input to the three-dimensional object detection portion 15-2 at the same time as when the three-dimensional sensor frame is input, and outputs the three-dimensional sensor object detection result generated from the two-dimensional image frame to the object-tracking apparatus 20.

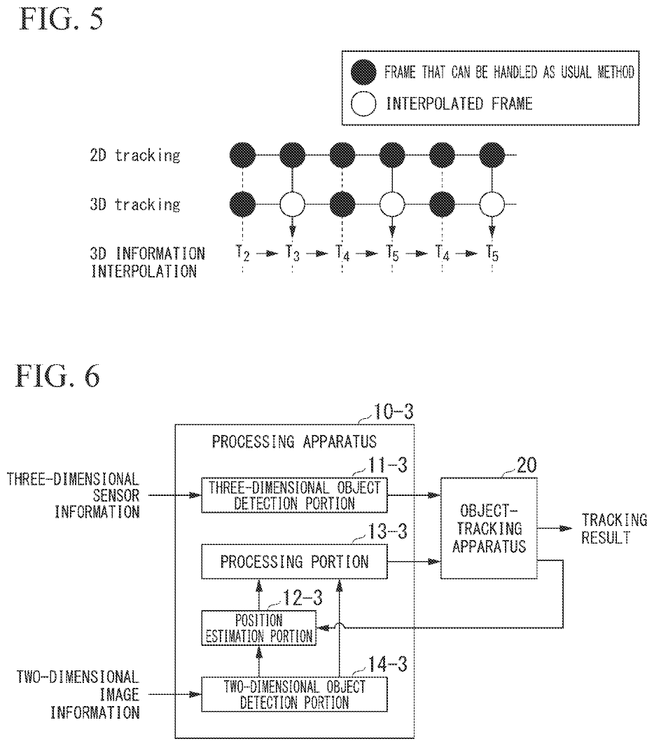

FIG. 5 is a view showing an example 4 of an operation of the processing apparatus of the object-tracking system according to the present embodiment. In FIG. 5, a lateral direction indicates time, a black circle indicates a frame that can be handled as usual, and a white circle indicates an interpolated frame. The black circles aligned next to the 2D tracking indicate two-dimensional image frames for which detection of an object is performed by the two-dimensional object detection portion 14-2, and the black circles aligned next to the 3D tracking indicate three-dimensional sensor frames for which detection of an object is performed by the three-dimensional object detection portion 11-2. The white circles aligned next to the 3D tracking indicate missing three-dimensional sensor frames.

Among the two-dimensional image frames, the same number of frames as the three-dimensional sensor frames are input to the two-dimensional object detection portion 14-2, and the rest of the frames are input to the three-dimensional object detection portion 15-2. The three-dimensional object detection portion 15-2 performs interpolation of the 3D feature by using the Monocular 3D Object Detection. For example, the three-dimensional object detection portion 15-2 extracts a heat map from pixels included in the two-dimensional image information of the two-dimensional image frame, estimates a pixel of a center point of an object, and thereby estimates a three-dimensional position, a size, and an orientation of the object and a type of the object. The three-dimensional object detection portion 15-2 causes a result of estimating the three-dimensional position, the size, and the orientation of the object and the type of the object to return to the bounding box. The three-dimensional object detection portion 15 also extracts depth information of the object from the two-dimensional image information of the two-dimensional image frame and performs interpolation of the three-dimensional feature.

FIG. 6 is a view showing an example 3 of a processing apparatus of the object-tracking system according to the present embodiment. When a two-dimensional image frame is missing, the processing apparatus 10-3 performs interpolation by using two-dimensional image information of a two-dimensional image frame other than the missing two-dimensional image frame. The processing apparatus 10-3 includes a three-dimensional object detection portion 11-3, a position estimation portion 12-3, a processing portion 13-3, and a two-dimensional object detection portion 14-3.

The three-dimensional object detection portion 11-1 or the three-dimensional object detection portion 11-2 can be applied to the three-dimensional object detection portion 11-3. The two-dimensional object detection portion 14-1 can be applied to the two-dimensional object detection portion 14-3. However, when a two-dimensional image frame is missing, the two-dimensional object detection portion 14-3 acquires one or more two dimensional image frames close to the missing two-dimensional image frame and generates a bounding box on each of the acquired one or more two-dimensional image frames. The two-dimensional object detection portion 14-1 adds information indicating the type of an object to the object in the bounding box generated on each of the one or more two-dimensional image frames.

The position estimation portion 12-3 estimates a position of an object interpolated based on the position of the bounding box generated on the one or more two-dimensional image frames by the two-dimensional object detection portion 14-3. For example, the position estimation portion 12-3 estimates the position of the interpolated object by using the IoU. Details of the process of estimating the position of an interpolated object will be described later.

The processing portion 13-3 acquires a result of adding the information indicating the type of the object to the object in the bounding box generated on each of the one or more two-dimensional image frames from the two-dimensional object detection portion 14-3, and acquires an estimation result of the position of the interpolated object from the position estimation portion 12-3. The processing portion 13-3 interpolates the two-dimensional image frame based on the acquired estimation result of the position of the interpolated object. For example, the processing portion 13-3 includes a two-dimensional Kalman filter, and the two-dimensional Kalman filter has position information of an object as an internal state. The two-dimensional Kalman filter outputs a feature of the object by updating the internal state based on the estimation result of the position of the interpolated object. The processing portion 13-3 interpolates the two-dimensional image frame by the feature of the object output by the two-dimensional Kalman filter. The processing portion 13-3 generates a bounding box for a result of interpolating the two-dimensional image frame by the feature of the object. The processing portion 13-3 acquires a two-dimensional image object detection result of an object to which predetermined information indicating the classification of the object is added among objects surrounded by the generated bounding box. The processing portion 13-3 outputs the acquired two-dimensional image object detection result to the object-tracking apparatus 20.

The object-tracking apparatus 20 acquires the three-dimensional sensor object detection result that is output by the three-dimensional object detection portion 11-1 and acquires the two-dimensional object detection result that is output by the processing portion 13-3. The object-tracking apparatus 20 tracks an object based on the acquired three-dimensional sensor object detection result and the acquired two-dimensional object detection result. The object-tracking apparatus 20 may output the result of the two-dimensional object tracking or the result of the three-dimensional object tracking to the position estimation portion 12-3. According to such a configuration, since the position estimation portion 12-3 can acquire track information (tracking information) to the previous frame based on the result of the two-dimensional object tracking or the result of the three-dimensional object tracking that are output by the object-tracking apparatus 20, the acquired track information to the previous frame can be used for the update (estimation of a position) of position information.

### Process of Estimating Position

Details of a process of estimating a position of an object interpolated by the position estimation portion 12-3 are described. The position estimation portion 12-3 estimates the position of an object interpolated based on one or more two-dimensional sensor frames close to the missing two-dimensional sensor frame. As an example, the case where the position estimation portion 12-3 estimates the position of an object interpolated based on two two-dimensional image frames acquired prior to a missing two-dimensional sensor frame is described.

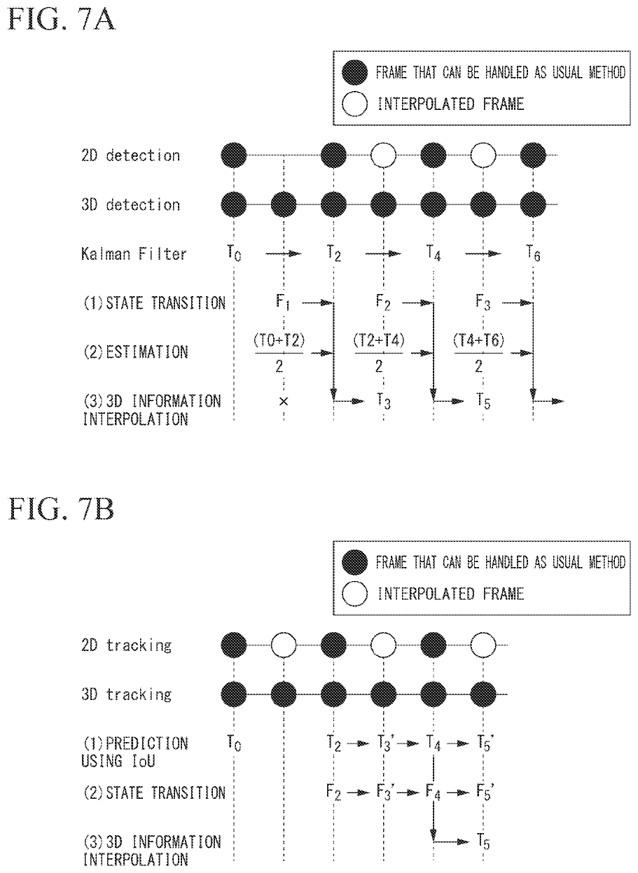

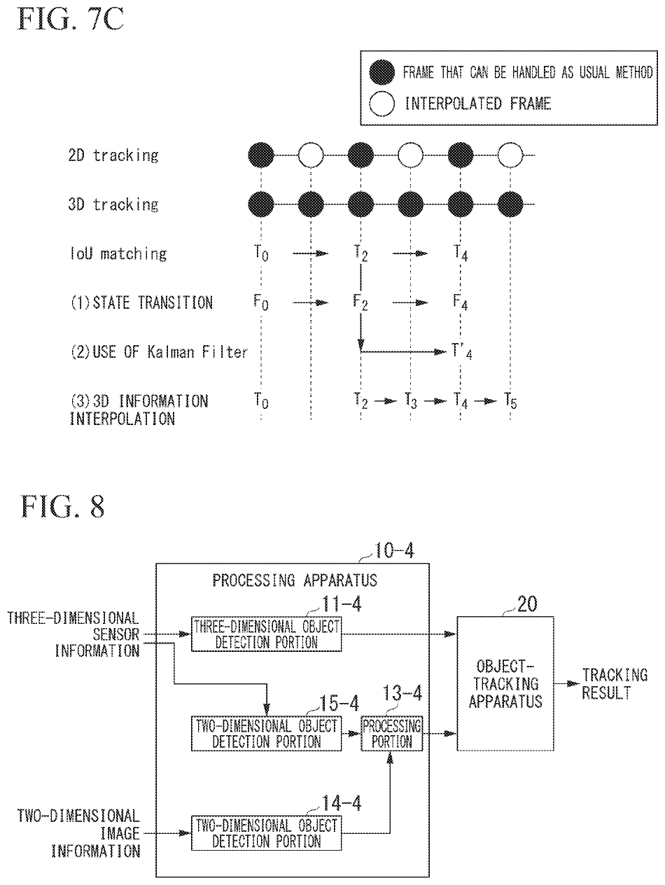

FIG. 7A is a view showing an example 5 of an operation of the processing apparatus of the object-tracking system according to the present embodiment. With reference to FIG. 7A, the case in which the interpolation is performed using an average value is described. In FIG. 7A, a lateral direction indicates time, a black circle indicates a frame that can be handled as usual, and a white circle indicates an interpolated frame. The black circles aligned next to the 2D detection indicate two-dimensional image frames for which detection of an object is performed by the two-dimensional object detection portion 14-3, and the black circles aligned next to the 3D detection indicate three-dimensional sensor frames for which detection of an object is performed by the three-dimensional object detection portion 11. The white circles aligned next to the 2D detection indicate missing two-dimensional image frames.

In the processing portion 13-3, the 2D Kalman filter is updated to a state transition vector F1 by the result of detection of an object by the two-dimensional object detection portion 14-3 at a time T0 (1). The position estimation portion 12-3 acquires the result of detection of the object by the two-dimensional object detection portion 14-3 at a time T2. When a two-dimensional image frame at a time T3 is missing, the position estimation portion 12-3 derives a position at the time T0 and a position at the time T2 by using tracking information at the time T0 and tracking information at the time T2.

The position estimation portion 12-3 estimates a position at the time T3 from the position at the time T2 and the position at the time T0. For example, the position estimation portion 12-3 obtains a difference between the position at the time T0 and the position at the time T2 and estimates the position at the time T3 by adding the obtained difference divided by two to the position at the time T2 (2).

The estimation result of the position at the time T3 is input to the two-dimensional Kalman filter in the processing portion 13-3, and the feature of the object is acquired. The processing portion 13-3 performs interpolation using the feature of the object output by the two-dimensional Kalman filter (3).

Even when a two-dimensional image frame at a time T5 is missing, a similar process is performed by using the tracking information at the time T2 and the tracking information at the time T4, the estimation result of the position at the time T5 is input to the two-dimensional Kalman filter in the processing portion 13-3, and the feature of the object is acquired. The processing portion 13-3 performs interpolation using the feature of the object output by the two-dimensional Kalman filter (3).

FIG. 7B is a view showing an example 6 of an operation of the processing apparatus of the object-tracking system according to the present embodiment. With reference to FIG. 7B, the case in which the interpolation is performed by assuming a linear motion is described. In FIG. 7B, a lateral direction indicates time, a black circle indicates a frame that can be handled as usual, and a white circle indicates an interpolated frame. The black circles aligned next to the 2D tracking indicate two-dimensional image frames for which detection of an object is performed by the two-dimensional object detection portion 14-3, and the black circles aligned next to the 3D tracking indicate three-dimensional sensor frames for which detection of an object is performed by the three-dimensional object detection portion 11. The white circle aligned next to the 2D tracking indicates a missing two-dimensional image frame.

The position estimation portion 12-3 acquires a result of detection of an object by the two-dimensional object detection portion 14-3 at a time T2. The position estimation portion 12-3 acquires a result of detection of an object by the two-dimensional object detection portion 14-3 at a time T4. When a two-dimensional image frame at a time T5 is missing, the position estimation portion 12-3 derives a position at the time T2 and a position at the time T4 by using tracking information at the time T2 and tracking information at the time T4 (1). The position estimation portion 12-3 assumes a linear motion by using the position at the time T2 and the position at the time T4, derives a speed from a time T0 to the time T2 based on the position at the time T0 and the position at the time T2, and derives a speed from the time T2 to the time T4 based on the position at the time T2 and the position at the time T4.

The position estimation portion 12-3 derives the acceleration from the difference between the speed from the time T0 to the time T2 and the speed from the time T2 to the time T4. The position estimation portion 12-3 estimates the position at the time T5 by using the derived acceleration. The estimation result of the position at the time T5 is input to the two-dimensional Kalman filter in the processing portion 13-3, and the feature of the object is acquired (2). The processing portion 13-3 performs interpolation using the feature of the object output by the two-dimensional Kalman filter (3).

FIG. 7C is a view showing an example 7 of an operation of the processing apparatus of the object-tracking system according to the present embodiment. With reference to FIG. 7C, the case in which a Kalman filter is used is described. In FIG. 7C, a lateral direction indicates time, a black circle indicates a frame that can be handled as usual, and a white circle indicates an interpolated frame. The black circles aligned next to the 2D tracking indicate two-dimensional image frames for which detection of an object is performed by the two-dimensional object detection portion 14, and the black circles aligned next to the 3D tracking indicate three-dimensional sensor frames for which detection of an object is performed by the three-dimensional object detection portion 11-3. The white circles aligned next to the 2D tracking indicate missing two-dimensional image frames.

The position estimation portion 12-3 acquires the result of detection of the object by the two-dimensional object detection portion 14-3 at a time T2. When a two-dimensional sensor frame at a time T3 is missing, the position estimation portion 12-3 derives a position at the time T2 by using tracking information at the time T2.

The position estimation portion 12-3 inputs the position information at the time T2 into the two-dimensional Kalman filter of the processing portion 13 and acquires position information at a time T4 output by the two-dimensional Kalman filter ((1), (2)). The position estimation portion 12-3 derives a change amount of the position between the time T2 and the time T4 by dividing the difference between the position at the time T4 and the position at the time T2 by two on the basis of the acquired position information at the time T4 and the position information at the time T2. The position estimation portion 12-3 estimates a position at the time T3 from the derived change amount of the position. The estimation result of the position at the time T3 is input to the two-dimensional Kalman filter in the processing portion 13-3, and the feature of the object is acquired. The processing portion 13-3 performs interpolation using the feature of the object output by the two-dimensional Kalman filter (3).

Even when a two-dimensional image frame at a time T5 is missing, a similar process is performed by using the tracking information at the time T2, and thereby, the position at the time T5 is estimated. The estimation result of the position at the time T5 is input to the two-dimensional Kalman filter in the processing portion 13-3, and the feature of the object is acquired. The processing portion 13-3 performs interpolation using the feature of the object output by the two-dimensional Kalman filter.

FIG. 8 is a view showing an example 8 of a processing apparatus of the object-tracking system according to the present embodiment. When a two-dimensional image frame is missing, the processing apparatus 10-4 performs interpolation by using three-dimensional sensor information of a three-dimensional sensor frame. The processing apparatus 10-4 includes a three-dimensional object detection portion 11-4, a processing portion 13-4, a two-dimensional object detection portion 14-4, and a two-dimensional object detection portion 16-4.

The three-dimensional object detection portion 11-1 or the three-dimensional object detection portion 11-3 can be applied to the three-dimensional object detection portion 11-4. The two-dimensional object detection portion 14-1 or the two-dimensional object detection portion 14-3 can be applied to the two-dimensional object detection portion 14-4. However, when the two-dimensional image frame is missing, the two-dimensional object detection portion 14-4 commands the processing portion 13-4 to output a two-dimensional image object detection result to the object-tracking apparatus 20.

A three-dimensional sensor frame is input to the two-dimensional object detection portion 16-4. The two-dimensional object detection portion 16-4 generates a bounding box on the input three-dimensional sensor frame by the 3D Object Detection. The two-dimensional object detection portion 16-4 adds information indicating the type of an object to the object in the bounding box generated on the three-dimensional sensor frame.

The processing portion 13-4 acquires a two-dimensional image object detection result from an object point group to which predetermined information indicating the classification of the object is added among object point groups surrounded by the bounding box generated on the three-dimensional sensor frame. When a command to output the two-dimensional image object detection result to the object-tracking apparatus 20 is input from the two-dimensional object detection portion 14-4, the processing portion 13-4 outputs the acquired two-dimensional image object detection result to the object-tracking apparatus 20.

For example, the two-dimensional object detection portion 16-4 performs interpolation of the feature of a two-dimensional object by using a Point-GNN. The Point-GNN is a method of extracting the feature of the two-dimensional object by connecting point groups to form a graph. According to feature extraction using a graph, it is possible to save the number of times of grouping and sampling of point groups and prevent a calculation amount from increasing. By using this method that is light and can utilize a large amount information of point groups, it is possible to extract information (2D feature) of two-dimensional object detection from point groups, and therefore, the two-dimensional feature can be interpolated.

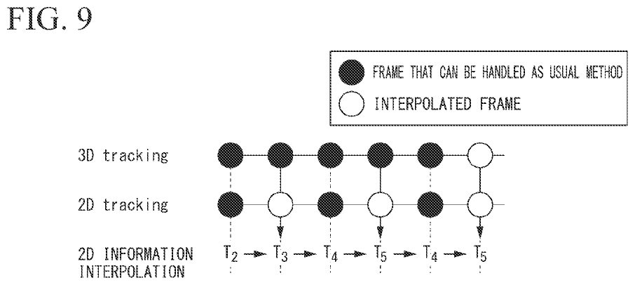

FIG. 9 is a view showing an example 8 of an operation of the processing apparatus of the object-tracking system according to the present embodiment. In FIG. 9, a lateral direction indicates time, a black circle indicates a frame that can be handled as usual, and a white circle indicates an interpolated frame. The black circles aligned next to the 2D tracking indicate two-dimensional image frames for which detection of an object is performed by the two-dimensional object detection portion 14-4, and the black circles aligned next to the 3D tracking indicate three-dimensional sensor frames for which detection of an object is performed by the three-dimensional object detection portion 11-4. The white circles aligned next to the 2D tracking indicate missing two-dimensional image frames.

Among the three-dimensional sensor frames, the same number of frames as the two-dimensional image frames are input to the three-dimensional object detection portion 11-4, and the rest of the frames are input to the two-dimensional object detection portion 16-4. The two-dimensional object detection portion 16-4 performs interpolation of the two-dimensional feature by using the Point-GNN.

All or some of the three-dimensional object detection portions 11-1 to 11-4, the position estimation portions 12-1, 12-3, the processing portions 13-1 to 13-4, the two-dimensional object detection portions 14-1 to 14-4, the three-dimensional object detection portion 15-2, and the two-dimensional object detection portion 16-4 are, for example, functional portions (hereinafter, referred to as a software function portion) realized by a processor such as a CPU (Central Processing Unit) executing a program stored in a storage portion (not shown).

All or some of the three-dimensional object detection portions 11-1 to 11-4, the position estimation portions 12-1, 12-3, the processing portions 13-1 to 13-4, the two-dimensional object detection portions 14-1 to 14-4, the three-dimensional object detection portion 15-2, and the two-dimensional object detection portion 16-4 may be realized by hardware such as a LSI (Large-Scale Integration), an ASIC (Application-Specific Integrated Circuit), or a FPGA (Field-Programmable Gate Array) or may be realized by the software function portion and hardware in cooperation.

### Operation of Object-Tracking System

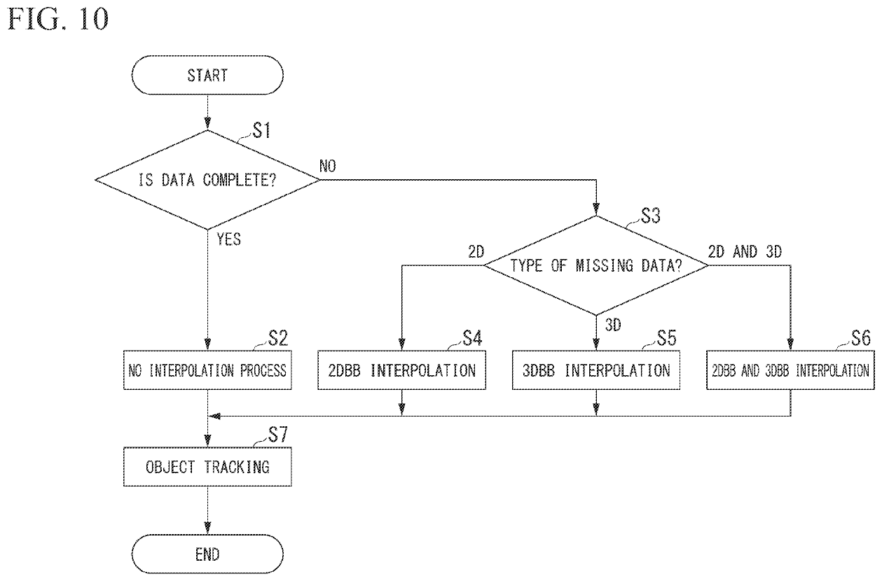

FIG. 10 is a view showing an example of an operation of the object-tracking system according to the present embodiment. With reference to FIG. 10, a process in which the object-tracking system 100 tracks an object is described. Hereinafter, an arbitrary three-dimensional object detection portion among the three-dimensional object detection portions 11-1 to 11-4 is described as a three-dimensional object detection portion 11, an arbitrary processing portion among the processing portions 13-1 to 13-4 is described as a processing portion 13, and an arbitrary two-dimensional object detection portion among the two-dimensional object detection portions 14-1 to 14-4 is described as a two-dimensional object detection portion 14.

### Step S1

In the processing apparatus 10, the three-dimensional object detection portion 11 and the two-dimensional object detection portion 14 determine whether or not the three-dimensional sensor frame and the two-dimensional image frame are complete, respectively.

### Step S2

In the processing apparatus 10, when the three-dimensional object detection portion 11 and the two-dimensional object detection portion 14 determine that the three-dimensional sensor frame and the two-dimensional image frame are complete, respectively (Step S1: YES), the processing portion 13 does not perform the interpolation process.

### Step S3

In the processing apparatus 10, when at least one of the three-dimensional object detection portion 11 and the two-dimensional object detection portion 14 determines that one of the three-dimensional sensor frame and the two-dimensional image frame is not complete (Step S1: NO), the three-dimensional object detection portion 11 and the two-dimensional object detection portion 14 determine the type of missing data.

### Step S4

In the processing apparatus 10, when the two-dimensional object detection portion 14 determines that the two-dimensional image frame is not complete (Step S3: 2D), the following process is performed. The processing portion 13-3 acquires a result of adding information indicating the type of an object to the object in a bounding box generated on each of one or more two-dimensional image frames from the two-dimensional object detection portion 14-3, and acquires an estimation result of a position of an interpolated object from the position estimation portion 12-3. The processing portion 13-3 interpolates the two-dimensional image frame based on the acquired estimation result of the position of the interpolated object. Alternatively, the processing portion 13-4 acquires a two-dimensional image object detection result of an object to which predetermined information indicating the classification of the object is added among objects surrounded by a bounding box generated on a three-dimensional sensor frame. When a command to output the two-dimensional image object detection result to the object-tracking apparatus 20 is input from the two-dimensional object detection portion 14-4, the processing portion 13-4 outputs the acquired two-dimensional image object detection result to the object-tracking apparatus 20.

### Step S5

In the processing apparatus 10, when the three-dimensional object detection portion 11 determines that the three-dimensional sensor frame is not complete (Step S3: 3D), the following process is performed. The processing portion 13-1 acquires a result of adding information indicating the type of an object to the object in a bounding box generated on each of one or more three-dimensional sensor frames from the three-dimensional object detection portion 11-1, and acquires an estimation result of a position of an interpolated object from the position estimation portion 12-1. The processing portion 13-1 interpolates the three-dimensional sensor frame based on the acquired estimation result of the position of the interpolated object. Alternatively, when a command to output a three-dimensional sensor object detection result to the object-tracking apparatus 20 is input from the three-dimensional object detection portion 11-2, the processing portion 13-2 outputs the acquired three-dimensional sensor object detection result to the object-tracking apparatus 20.

### Step S6

In the processing apparatus 10, when the two-dimensional object detection portion 14 determines that the two-dimensional image frame is not complete and when the three-dimensional object detection portion 11 determines that the three-dimensional sensor frame is not complete (Step S3: 2D and 3D), the following process is performed. The processing portion 13-1 acquires a result of adding information indicating the type of an object to the object in a bounding box generated on each of one or more three-dimensional sensor frames from the three-dimensional object detection portion 11-1, and acquires an estimation result of a position of an interpolated object from the position estimation portion 12-1. The processing portion 13-1 interpolates the three-dimensional sensor frame based on the acquired estimation result of the position of the interpolated object. Alternatively, when a command to output a three-dimensional sensor object detection result to the object-tracking apparatus 20 is input from the three-dimensional object detection portion 11-2, the processing portion 13-2 outputs the acquired three-dimensional sensor object detection result to the object-tracking apparatus 20.

Further, the processing portion 13-3 interpolates the two-dimensional image frame based on the acquired estimation result of the position of the interpolated object. Alternatively, the processing portion 13-4 acquires a two-dimensional image object detection result of an object to which predetermined information indicating the classification of the object is added among objects surrounded by a bounding box generated on a three-dimensional sensor frame. When a command to output the two-dimensional image object detection result to the object-tracking apparatus 20 is input from the two-dimensional object detection portion 14-4, the processing portion 13-4 outputs the acquired two-dimensional image object detection result to the object-tracking apparatus 20.

### Step S7

The processing apparatus 10 outputs the two-dimensional image object detection result and the three-dimensional sensor object detection result to the object-tracking apparatus 20. The object-tracking apparatus 20 performs two-dimensional object tracking or three-dimensional object tracking by using the two-dimensional image object detection result and the three-dimensional sensor object detection result that are acquired from the processing apparatus 10.

The effects of the object-tracking system according to the present embodiment are described separately for the case where a missing three-dimensional sensor frame is interpolated and for the case where a missing two-dimensional image frame is interpolated.

Data set is described. The case where a missing three-dimensional sensor frame is interpolated is described. As the data set, as an example, KITTI that is widely utilized for self-driving is utilized; however, the data set is not limited thereto, and another data set can be utilized. 7480 images for Detection and 8008 Tracking images divided into 21 scenes are prepared for the KITTI data set. There are three classes of objects, namely an automobile, a pedestrian, and a bicycle, and classes are also divided depending on the detection difficulty degree of objects. The images and point group data for Detection and teacher data of object detection thereof were used for learning and evaluation, and images and point group data for Tracking and teacher data of object detection thereof were used for testing. Further, only the automobile was treated for the classes of objects. The degree of difficulty of detection was not classified, and data of all the degrees of difficulty were used for learning, evaluation, and testing.

A missing three-dimensional sensor frame was assumed, the input of the three-dimensional sensor frame in the KITTI data set was set to 5 FPS, and the input of the two-dimensional image frame was set to 10 FPS. Experiments were performed using a method in which when a three-dimensional sensor frame was missing, interpolation was performed by using three-dimensional sensor information of a three-dimensional sensor frame other than the missing three-dimensional sensor frame and a method in which when a three-dimensional sensor frame was missing, interpolation was performed by using two-dimensional image information of a two-dimensional image frame. For comparison, experiments were also performed on a method in which 5 FPS three-dimensional sensor frames and 10 FPS two-dimensional image frames were input, but interpolation was not performed at all and a method in which 10 FPS three-dimensional sensor frames and 10 FPS two-dimensional image frames were input, but interpolation was not performed at all.

The evaluation index is described. As the evaluation index, MOTA (Multiple Object Tracking Accuracy) used for measuring the detection accuracy of a bounding box, sAMOTA (scaled Average MOTA) obtained by integrating the MOTA, and AMOTA (Average MOTA) obtained by calculating the average value were utilized. The MOTA indicates the ratio of the number of the bounding boxes of estimation to the number of the bounding boxes of the correct answer. The sAMOTA is an evaluation index obtained by integrating the function of the MOTA and adjusting the integration result to be in a range from 0 (minimum) to 1 (maximum). The AMOTA represents the average value of the MOTA.

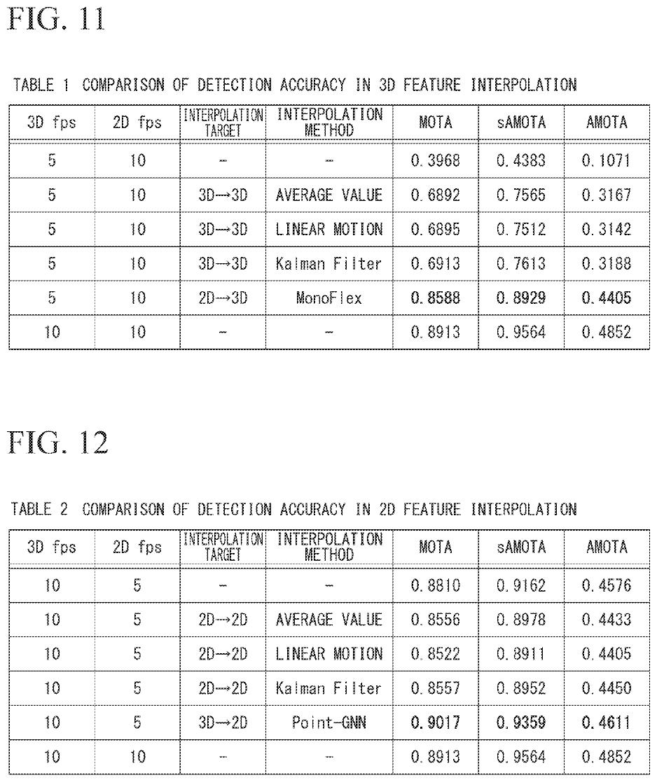

FIG. 11 is a view showing an example 1 of an effect of the object-tracking system according to the present embodiment. Since a missing three-dimensional sensor frame is assumed in FIG. 11, the input of the two-dimensional image frame was fixed to 10 FPS and the input FPS of the three-dimensional sensor frame was changed.

In FIG. 11, four middle rows (from a second line to a fifth line) excluding uppermost and lowermost rows are data for methods in which Tracking was performed together with interpolation. The second line represents the case in which the interpolation was performed using an average value, the third line represents the case in which the interpolation was performed by assuming a linear motion, the fourth line represents the case in which a Kalman filter was used, and the fifth line indicates the case in which MonoFlex was used. A significant difference in the accuracy depending on the method was not found for the methods from the second line to the fourth line in which 3D to 3D information interpolation was performed. It was found that in the method in which 2D to 3D information interpolation was performed, effective use of images was successful, and even the input of 5 FPS was comparable to the case in which LiDAR of 10 FPS is used.

A missing two-dimensional image frame was assumed, the input of the two-dimensional image frame in the KITTI data set was set to 5 FPS, and the input of the three-dimensional sensor frame was set to 10 FPS. Experiments were performed using a method in which when a two-dimensional image frame was missing, interpolation was performed by using two-dimensional image information of a two-dimensional image frame other than the missing two-dimensional image frame and a method in which when a two-dimensional image frame was missing, interpolation was performed by using two-dimensional image information of a three-dimensional sensor frame. For comparison, experiments were also performed on a method in which 5 FPS three-dimensional sensor frames and 10 FPS two-dimensional image frames were input, but interpolation was not performed at all and a method in which 10 FPS three-dimensional sensor frames and 10 FPS two-dimensional image frames were input, but interpolation was not performed at all.

FIG. 12 is a view showing an example 2 of an effect of the object-tracking system according to the present embodiment. Since a missing two-dimensional image frame is assumed in FIG. 12, the input of the three-dimensional sensor frame was fixed to 10 FPS and the input FPS of the three-dimensional sensor frame was changed.

In FIG. 12, four middle rows (from a second line to a fifth line) excluding uppermost and lowermost rows are data for methods in which Tracking was performed together with interpolation. The second line represents the case in which the interpolation was performed using an average value, the third line represents the case in which the interpolation was performed by assuming a linear motion, the fourth line represents the case in which a Kalman filter was used, and the fifth line indicates the case in which the Point-GNN was used. A significant difference in the accuracy depending on the method was not found for the methods from the second line to the fourth line in which 2D to 2D information interpolation was performed. In the method in which 3D to 2D information interpolation was performed, effective use of LiDAR frames was successful, even the input of 5 FPS was comparable to the case in which a 10 FPS camera was used, and the score of the MOTA showed a higher value than when the 10 FPS camera is used.

According to the object-tracking system 100 of the present embodiment, the processing apparatus 10 includes: a processing portion (13-1, 13-2, 13-3, 13-4) that interpolates, when at least one of two-dimensional image information and three-dimensional sensor information that are input at an arbitrary time is missing, the missing two-dimensional image information or the missing three-dimensional sensor information and outputs an object detection result based on two-dimensional image information and three-dimensional sensor information obtained by interpolating the missing two-dimensional image information or the missing three-dimensional sensor information to an object-tracking apparatus. The processing portion interpolates the missing one of the two-dimensional image information and the three-dimensional sensor information with conversion of another of the two-dimensional image information and the three-dimensional sensor information, or interpolates the two-dimensional image information or the three-dimensional sensor information at a missing time with estimation based on two-dimensional image information or three-dimensional sensor information at another time. According to such a configuration, even when at least one of the two-dimensional image information and the three-dimensional sensor information that are input at an arbitrary time is missing, since it is possible to output the object detection result based on the two-dimensional image information and the three-dimensional sensor information obtained by interpolating the missing two-dimensional image information or the missing three-dimensional sensor information to the object-tracking apparatus 20, the three-dimensional sensor information and the two-dimensional image information can be integrated in the object-tracking apparatus 20, and the surrounding environment can be recognized.

Further, the processing apparatus 10 further includes: a three-dimensional object detection portion 11-1 that detects, when three-dimensional sensor information is missing, a three-dimensional object included in three-dimensional sensor information close to the missing three-dimensional sensor information; and a position estimation portion 12-1 that estimates a position of a three-dimensional object interpolated based on a position of the three-dimensional object detected by the three-dimensional object detection portion 11-1, wherein the processing portion 13-1 interpolates the missing three-dimensional sensor information based on position information of the interpolated three-dimensional object estimated by the position estimation portion 12-1. According to such a configuration, when three-dimensional sensor information is missing, since it is possible to estimate the position of the three-dimensional object interpolated based on the three-dimensional sensor information close to the missing three-dimensional sensor information, the missing three-dimensional sensor information can be interpolated based on the position information of the interpolated three-dimensional object.

Further, the three-dimensional object detection portion 11-1 detects a three-dimensional object included in each of a plurality of three-dimensional sensor information prior to the missing three-dimensional sensor information, and the position estimation portion 12-1 estimates the position of the interpolated three-dimensional object based on an average value of a plurality of positions of the three-dimensional object detected by the three-dimensional object detection portion 11-1. According to such a configuration, the position of the interpolated three-dimensional object can be estimated based on the average value of the plurality of positions of the three-dimensional object included in each of the plurality of three-dimensional sensor information prior to the missing three-dimensional sensor information.

Further, the three-dimensional object detection portion 11-1 detects a three-dimensional object included in each of a plurality of three-dimensional sensor information prior to the missing three-dimensional sensor information, and the position estimation portion 12-1 derives a movement speed and an acceleration from a plurality of positions of the three-dimensional object detected by the three-dimensional object detection portion 11-1 and estimates the position of the interpolated three-dimensional object based on the derived movement speed and the derived acceleration. According to such a configuration, since it is possible to derive the movement speed and the acceleration from the plurality of positions of the three-dimensional object included in each of the plurality of three-dimensional sensor information prior to the missing three-dimensional sensor information, the position of the interpolated three-dimensional object can be estimated based on the derived movement speed and the derived acceleration.

Further, the position estimation portion 12-1 estimates a position of the three-dimensional object after the missing three-dimensional sensor information from a position of the three-dimensional object detected by the three-dimensional object detection portion 11-1 and estimates the position of the interpolated three-dimensional object based on the estimated position of the three-dimensional object. According to such a configuration, since it is possible to estimate the position of the three-dimensional object after the missing three-dimensional sensor information from the position of the three-dimensional object, the position of the interpolated three-dimensional object can be estimated based on the estimated position of the three-dimensional object.

Further, the processing apparatus 10 further includes: a three-dimensional object detection portion 15-2 that detects, when three-dimensional sensor information is missing, a three-dimensional object from two-dimensional image information close to the missing three-dimensional sensor information, wherein the processing portion 13-2 interpolates the missing three-dimensional sensor information with the three-dimensional object detected by the three-dimensional object detection portion 15-2. According to such a configuration, when three-dimensional sensor information is missing, it is possible to detect a three-dimensional object from two-dimensional image information close to the missing three-dimensional sensor information, and therefore, the missing three-dimensional sensor information can be interpolated with the three-dimensional object detected by the three-dimensional object detection portion 15-2.

Further, the processing apparatus 10 further includes: a two-dimensional object detection portion 14-3 that detects, when two-dimensional image information is missing, a two-dimensional object included in two-dimensional image information close to the missing two-dimensional image information; and a position estimation portion 12-3 that estimates a position of a two-dimensional object interpolated based on a position of the two-dimensional object detected by the two-dimensional object detection portion 14-3, wherein the processing portion 13-3 interpolates the missing two-dimensional image information based on position information of the interpolated two-dimensional object estimated by the position estimation portion 12-3. According to such a configuration, when two-dimensional image information is missing, since it is possible to estimate the position of the two-dimensional object interpolated based on the two-dimensional image information close to the missing two-dimensional image information, the missing two-dimensional image information can be interpolated based on the position information of the interpolated two-dimensional object.

Further, the two-dimensional object detection portion 14-3 detects a two-dimensional object included in each of a plurality of two-dimensional image information prior to the missing two-dimensional image information, and the position estimation portion 12-3 estimates the position of the interpolated two-dimensional object based on an average value of a plurality of positions of the two-dimensional object detected by the two-dimensional object detection portion 14-3. According to such a configuration, the position of the interpolated two-dimensional object can be estimated based on the average value of the plurality of positions of the two-dimensional object included in each of the plurality of two-dimensional image information prior to the missing two-dimensional image information.

Further, the two-dimensional object detection portion 14-3 detects a two-dimensional object included in each of a plurality of two-dimensional image information prior to the missing two-dimensional image information, and the position estimation portion 12-3 derives a movement speed and an acceleration from a plurality of positions of the two-dimensional object detected by the two-dimensional object detection portion 14-3 and estimates the position of the interpolated two-dimensional object based on the derived movement speed and the derived acceleration. According to such a configuration, since it is possible to derive the movement speed and the acceleration from the plurality of positions of the two-dimensional object included in each of the plurality of two-dimensional image information prior to the missing two-dimensional image information, the position of the interpolated two-dimensional object can be estimated based on the derived movement speed and the derived acceleration.

Further, the position estimation portion 12-3 estimates a position of the two-dimensional object after the missing two-dimensional image information from a position of the two-dimensional object detected by the two-dimensional object detection portion 14-3 and estimates the position of the interpolated two-dimensional object based on the estimated position of the two-dimensional object. According to such a configuration, since it is possible to estimate the position of the two-dimensional object after the missing two-dimensional image information from the position of the two-dimensional object, the position of the interpolated two-dimensional object can be estimated based on the estimated position of the two-dimensional object.

Further, the processing apparatus 10 further includes: a two-dimensional object detection portion 16-4 that detects, when two-dimensional image information is missing, a two-dimensional object from three-dimensional sensor information close to the missing two-dimensional image information, wherein the processing portion 13-4 interpolates the missing two-dimensional image information with the two-dimensional object detected by the two-dimensional object detection portion 16-4. According to such a configuration, when two-dimensional image information is missing, it is possible to detect a two-dimensional object from two-dimensional image information close to the missing two-dimensional image information, and therefore, the missing two-dimensional image information can be interpolated with the two-dimensional object detected by the two-dimensional object detection portion 16-4.

Although modes for carrying out the present invention have been described above using the embodiments, the present invention is not limited to these embodiments, and various modifications and substitutions can be made without departing from the scope of the present invention.

What is claimed is:

1. A processing apparatus comprising:
a processing portion that interpolates, when at least one of two-dimensional image information and three-dimensional sensor information that are input at an arbitrary time is missing, the missing two-dimensional image information or the missing three-dimensional sensor information and outputs an object detection result based on two-dimensional image information and three-dimensional sensor information obtained by interpolating the missing two-dimensional image information or the missing three-dimensional sensor information to an object-tracking apparatus,
wherein the processing portion interpolates the missing one of the two-dimensional image information and the three-dimensional sensor information with conversion of another of the two-dimensional image information and the three-dimensional sensor information, or interpolates the two-dimensional image information or the three-dimensional sensor information at a missing time with estimation based on two-dimensional image information or three-dimensional sensor information at another time.

2. The processing apparatus according to claim 1, further comprising:
a three-dimensional object detection portion that detects, when three-dimensional sensor information is missing, a three-dimensional object included in three-dimensional sensor information close to the missing three-dimensional sensor information; and
a position estimation portion that estimates a position of a three-dimensional object interpolated based on a position of the three-dimensional object detected by the three-dimensional object detection portion,
wherein the processing portion interpolates the missing three-dimensional sensor information based on position information of the interpolated three-dimensional object estimated by the position estimation portion.

3. The processing apparatus according to claim 2,
wherein the three-dimensional object detection portion detects a three-dimensional object included in each of a plurality of three-dimensional sensor information prior to the missing three-dimensional sensor information, and
the position estimation portion estimates the position of the interpolated three-dimensional object based on an average value of a plurality of positions of the three-dimensional object detected by the three-dimensional object detection portion.

4. The processing apparatus according to claim 2,
wherein the three-dimensional object detection portion detects a three-dimensional object included in each of a plurality of three-dimensional sensor information prior to the missing three-dimensional sensor information, and
the position estimation portion derives a movement speed and an acceleration from a plurality of positions of the three-dimensional object detected by the three-dimensional object detection portion and estimates the position of the interpolated three-dimensional object based on the derived movement speed and the derived acceleration.

5. The processing apparatus according to claim 2,
wherein the position estimation portion estimates a position of the three-dimensional object after the missing three-dimensional sensor information from a position of the three-dimensional object detected by the three-dimensional object detection portion and estimates the position of the interpolated three-dimensional object based on the estimated position of the three-dimensional object.

6. The processing apparatus according to claim 1, further comprising:
a three-dimensional object detection portion that detects, when three-dimensional sensor information is missing, a three-dimensional object from two-dimensional image information close to the missing three-dimensional sensor information,
wherein the processing portion interpolates the missing three-dimensional sensor information with the three-dimensional object detected by the three-dimensional object detection portion.

7. The processing apparatus according to claim 1, further comprising:
a two-dimensional object detection portion that detects, when two-dimensional image information is missing, a two-dimensional object included in two-dimensional image information close to the missing two-dimensional image information; and
a position estimation portion that estimates a position of a two-dimensional object interpolated based on a position of the two-dimensional object detected by the two-dimensional object detection portion,
wherein the processing portion interpolates the missing two-dimensional image information based on position information of the interpolated two-dimensional object estimated by the position estimation portion.

8. The processing apparatus according to claim 7,
wherein the two-dimensional object detection portion detects a two-dimensional object included in each of a plurality of two-dimensional image information prior to the missing two-dimensional image information, and
the position estimation portion estimates the position of the interpolated two-dimensional object based on an average value of a plurality of positions of the two-dimensional object detected by the two-dimensional object detection portion.

9. The processing apparatus according to claim 7,
wherein the two-dimensional object detection portion detects a two-dimensional object included in each of a plurality of two-dimensional image information prior to the missing two-dimensional image information, and
the position estimation portion derives a movement speed and an acceleration from a plurality of positions of the two-dimensional object detected by the two-dimensional object detection portion and estimates the position of the interpolated two-dimensional object based on the derived movement speed and the derived acceleration.

10. The processing apparatus according to claim 7,
wherein the position estimation portion estimates a position of the two-dimensional object after the missing two-dimensional image information from a position of the two-dimensional object detected by the two-dimensional object detection portion and estimates the position of the interpolated two-dimensional object based on the estimated position of the two-dimensional object.

11. The processing apparatus according to claim 1, further comprising:
a two-dimensional object detection portion that detects, when two-dimensional image information is missing, a two-dimensional object from three-dimensional sensor information close to the missing two-dimensional image information,
wherein the processing portion interpolates the missing two-dimensional image information with the two-dimensional object detected by the two-dimensional object detection portion.

12. A method performed by a processing apparatus, the method comprising:
interpolating, when at least one of two-dimensional image information and three-dimensional sensor information that are input at an arbitrary time is missing, the missing two-dimensional image information or the missing three-dimensional sensor information;
outputting an object detection result based on two-dimensional image information and three-dimensional sensor information obtained by interpolating the missing two-dimensional image information or the missing three-dimensional sensor information to an object-tracking apparatus; and
when the missing two-dimensional image information or the missing three-dimensional sensor information is interpolated, interpolating the missing one of the two-dimensional image information and the three-dimensional sensor information with conversion of another of the two-dimensional image information and the three-dimensional sensor information, or interpolating the two-dimensional image information or the three-dimensional sensor information at a missing time with estimation based on two-dimensional image information or three-dimensional sensor information at another time.
